(19) United States
(12) Patent Application Publication
(10) Pub. No.: US 2026/0100156 A1
(43) Pub. Date: Apr. 9, 2026

(54) PIXEL CIRCUIT, DISPLAY DEVICE INCLUDING THE SAME AND THE ELECTRONIC DEVICE INCLUDING THE SAME

(71) Applicant: Samsung Display Co., LTD., Yongin-si (KR)

(72) Inventors: Taehun Lee, Yongin-si (KR); OHJO KWON, Yongin-si (KR)

(21) Appl. No.: 19/277,623

(22) Filed: Jul. 23, 2025

(30) Foreign Application Priority Data
Oct. 8, 2024 (KR) 10-2024-0136221

(51) Int. Cl. G09G 3/32; G09G 3/3233

(52) U.S. Cl. CPC G09G 3/32; G09G 3/3233; G09G 2300/043; G09G 2300/0819; G09G 2310/08

(57) ABSTRACT

A pixel circuit includes a driving transistor including a control electrode connected to a first node, a first electrode which receives a first power voltage and a second electrode connected to a second node, a write transistor, a control transistor including a control electrode which receives a control signal, a first electrode connected to the second node and a second electrode connected to a fourth node, an emission transistor which connects the fourth node and a fifth node to each other in response to an emission signal, a light emitting element initialization transistor which applies an initialization voltage to the fifth node in response to a bias signal and a light emitting element including a first electrode connected to the fifth node and a second electrode which receives a second power voltage. The control signal is a direct current voltage.

This application claims priority to Korean Patent Application No. 10-2024-0136221, filed on October 8, 2024, and all the benefits accruing therefrom under 35 U.S.C. §119, the content of which in its entirety is herein incorporated by reference.

### BACKGROUND

### 1. Field

Embodiments of the invention relate to a pixel circuit and display device including the pixel circuit. More particularly, embodiments of the invention relate to a pixel circuit with improved integration and a display device including the pixel circuit.

### 2. Description of the Related Art

Generally, a display device includes a display panel and a display panel driver. The display panel typically includes a plurality of gate lines, a plurality of data lines, a plurality of emission lines and a plurality of pixels. The display panel driver may include a gate driver for providing a gate signal to the gate lines, a data driver for providing a data voltage to the data lines and a driving controller for controlling the gate driver, the data driver and the emission driver.

### SUMMARY

Recently, a display device which provide virtual reality (VR) or augmented reality (AR) have been gaining prominence. For this purpose, a display device is desired to have a low area and high integration. In such a display device having a low area and high integration, since a pitch occupied by the pixel circuit is relatively narrowed, the number of transistors of the pixel circuit and the number of signals applied to the pixel circuit may have restriction.

Embodiments of the invention provide a pixel circuit with improved emission reliability.

Embodiments of the invention also provide a display device including the pixel circuit.

Embodiments of the invention also provide an electronic device including the pixel circuit.

According to embodiments, a pixel circuit includes a driving transistor including a control electrode connected to a first node, a first electrode which receives a first power voltage and a second electrode connected to a second node, where driving transistor generates a driving current based on a voltage of the first node, a write transistor which applies a data voltage to the driving transistor in response to a write gate signal, a control transistor including a control electrode which receives a control signal, a first electrode connected to the second node and a second electrode connected to a fourth node, an emission transistor which connect the fourth node and a fifth node in response to an emission signal, a light emitting element initialization transistor which apply an initialization voltage to the fifth node in response to a bias signal and a light emitting element including a first electrode connected to the fifth node and a second electrode which receives a second power voltage. The control signal is a direct current (DC) voltage.

In an embodiment, the DC voltage may be a voltage which turns on the control transistor.

In an embodiment, a frame period, during which the pixel circuit is driven, may include a write period, a holding period and an emission period. In the write period, the write gate signal may have an activation level. In the holding period, the bias signal may have an activation level, and the emission signal may have an activation level. In the emission period, the driving current may be applied to the fifth node.

In an embodiment, in the holding period, the control transistor may be turned on, the emission transistor may be turned on, and the light emitting element initialization transistor may be turned on.

In an embodiment, the display device may further include a storage capacitor including a first electrode connected to the first node and a second electrode connected to a third node, a first initialization transistor which applies a reference voltage to the third node in response to an initialization gate signal, a second initialization transistor which applies the reference voltage to the first node in response to a previous write gate signal and a compensation transistor which connects the first node and the second node to each other in response to the write gate signal. The write transistor may apply the data voltage to the third node in response to the write gate signal.

In an embodiment, a frame period, during which the pixel circuit is driven, may include first to fourth periods. In the first period, the bias signal may have an activation level, the emission signal may have an inactivation level, the previous write gate signal may have an activation level, and the initialization gate signal may have an activation level.

In an embodiment, in a second period following to the first period, the bias signal may have an activation level, the emission signal may have an inactivation level, the previous write gate signal may have an inactivation level, the initialization gate signal may have an inactivation level, and the write gate signal may have an activation level.

In an embodiment, in the second period the driving transistor and the compensation transistor may be turned on.

In an embodiment, in a third period following to the second period, the bias signal may have an activation level, the emission signal may have an activation level, and the write gate signal may have an inactivation level.

In an embodiment, in the third period, the light emitting element transistor may be turned on, the emission transistor may be turned on, and the control transistor may be turned on.

In an embodiment, in a fourth period following to the third period, the bias signal may have an inactivation level, and the emission signal may have an activation level.

In an embodiment, during the first to fourth periods, the control signal may be maintained as a control voltage.

In an embodiment, the write transistor may include a control electrode which receives the write gate signal, a first electrode which receives the data voltage and a second electrode connected to the third node. The compensation transistor may include a control electrode which receives the write gate signal, a first electrode connected to the second node and a second electrode connected to the first node. The emission transistor may include a control electrode which receives the emission signal, a first electrode connected to the fourth node and a second electrode connected to the fifth node. The light emitting element transistor may include a control electrode which receives the bias signal, a first electrode which receives the initialization voltage and a second electrode connected to the fifth node. The first initialization transistor may include a control electrode which receives the initialization gate signal, a first electrode which receives the reference voltage and a second electrode connected to the third node. The second initialization transistor may include a control electrode which receives the previous write gate signal, a first electrode which receives the reference voltage and a second electrode connected to the first node. The control transistor may include a control electrode which receives the control signal, a first electrode connected to the second node and a second electrode connected to the fourth node.

According to embodiments, a pixel circuit includes a driving transistor including a control electrode connected to a first node, a first electrode which receives a first power voltage and a second electrode connected to a second node, and which generates a driving current based on a voltage of the first node, a write transistor which applies a data voltage to the driving transistor in response to a write gate signal, an emission transistor which connects the second node and a fourth node to each other in response to an emission signal, a light emitting element initialization transistor which applies an initialization voltage to the fourth node in response to a bias signal and a light emitting element including a first electrode connected to the fourth node and a second electrode which receives a second power voltage. The emission signal toggles between a first emission voltage and a second emission voltage lower than the first emission voltage. An absolute value of the second emission voltage is lower than a value obtained by subtracting an absolute value of a threshold voltage of the emission transistor from a value obtained by adding a voltage of the second electrode of the driving transistor and the second power voltage.

In an embodiment, a frame period, during which the pixel circuit is driven, may include a write period, a holding period and an emission period. In the write period, the write gate signal may have an activation level. In the holding period, the bias signal may have an activation level, and the emission signal may have an activation level. In the emission period, the driving current may be applied to the fourth node.

In an embodiment, in the emission period, the emission signal may have a third emission voltage lower than the second emission voltage.

In an embodiment, the display device may further include a storage capacitor including a first electrode connected to the first node and a second electrode connected to a third node, a first initialization transistor which applies a reference voltage to the third node in response to an initialization gate signal, a second initialization transistor which applies the reference voltage to the first node in response to a previous write gate signal and a compensation transistor which connects the first node and the second node to each other in response to the write gate signal. The write transistor may apply the data voltage to the third node in response to the write gate signal.

In an embodiment, a frame period, during which the pixel circuit is driven, may include first to fourth periods. In the first period, the bias signal may have an activation level, the emission signal may have an inactivation level, the previous write gate signal may have an activation level, and the initialization gate signal may have an activation level.

In an embodiment, in a second period following to the first period, the bias signal may have an activation level, the emission signal may have an inactivation level, the previous write gate signal may have an inactivation level, the initialization gate signal may have an inactivation level, and the write gate signal may have an activation level.

In an embodiment, in a third period following to the second period, the bias signal may have an activation level, the emission signal may have an activation level, and the write gate signal may have an inactivation level.

In an embodiment, in a fourth period following to the third period, the bias signal may have an inactivation level, and the emission signal may have an activation level.

According to embodiments, a pixel circuit includes a driving transistor including a control electrode connected to a first node, a first electrode which receives a first power voltage and a second electrode connected to a second node, where the driving transistor generates a driving current based on a voltage of the first node, a write transistor which applies a data voltage to the driving transistor in response to a write gate signal, an emission transistor which connects the second node and a fourth node to each other in response to an emission signal, a light emitting element initialization transistor which applies an initialization voltage to the fourth node in response to a bias signal and a light emitting element including a first electrode connected to the fourth node and a second electrode which receives a second power voltage. The emission signal toggles between a first emission voltage and a second emission voltage lower than the first emission voltage. The write gate signal toggles between a first gate voltage and a second gate voltage lower than the first gate voltage. An absolute value of the second emission voltage is lower than an absolute value of the second gate voltage.

In an embodiment, a frame period, during which the pixel circuit is driven, may include a write period, a holding period and an emission period. In the write period, the write gate signal may have an activation level. In the holding period, the bias signal may have an activation level, and the emission signal may have an activation level. In the emission period, the driving current may be applied to the fourth node.

In an embodiment, the pixel circuit may further include a storage capacitor including a first electrode connected to the first node and a second electrode connected to a third node, a first initialization transistor which applies a reference voltage to the third node in response to an initialization gate signal, a second initialization transistor which applies the reference voltage to the first node in response to a previous write gate signal and a compensation transistor which connects the first node and the second node to each other in response to the write gate signal. The write transistor may apply the data voltage to the third node in response to the write gate signal.

In an embodiment, a display device includes a display panel including a pixel circuit, a gate driver which outputs gate signals to the pixel circuit, an emission driver which outputs an emission signal to the pixel circuit, a voltage generator which applies a power voltage to the display panel and a driving controller which controls the gate driver, the emission driver and the voltage generator. The pixel circuit includes a driving transistor including a control electrode connected to a first node, a first electrode which receives a first power voltage and a second electrode connected to a second node, where the driving transistor generates a driving current based on a voltage of the first node, a write transistor which apply the data voltage to the driving transistor in response to a write gate signal, a control transistor including a control electrode which receives a control signal, a first electrode connected to the second node and a second electrode connected to a fourth node, an emission transistor which connects the fourth node and a fifth node to each other in response to the emission signal, a light emitting element initialization transistor which applies an initialization voltage to the fifth node in response to a bias signal and a light emitting element including a first electrode connected to the fifth node and a second electrode which receives a second power voltage. The voltage generator outputs the control signal. The control signal is a direct current (DC) voltage.

In an embodiment, the DC voltage may be a voltage which turns on the control transistor.

In an embodiment, a frame period, during which the pixel circuit is driven, may include a write period, a holding period and an emission period. In the write period, the write gate signal may have an activation level. In the holding period, the bias signal may have an activation level, and the emission signal may have an activation level. In the emission period, the driving current may be applied to the fifth node.

In an embodiment, in the holding period, the control transistor may be turned on, the emission transistor may be turned on, and the light emitting element initialization transistor may be turned on.

According to embodiments, an electronic device includes a display panel including a pixel circuit, a gate driver which outputs gate signals to the pixel circuit, an emission driver which outputs an emission signal to the pixel circuit, a voltage generator which applies a power voltage to the display panel and a driving controller which controls the gate driver, the emission driver and the voltage generator. The pixel circuit includes a driving transistor including a control electrode connected to a first node, a first electrode which receives a first power voltage and a second electrode connected to a second node, where the driving transistor generates a driving current based on a voltage of the first node, a write transistor which applies the data voltage to the driving transistor in response to a write gate signal, a control transistor including a control electrode which receives a control signal, a first electrode connected to the second node and a second electrode connected to a fourth node, an emission transistor which connects the fourth node and a fifth node to each other in response to the emission signal, a light emitting element initialization transistor which applies an initialization voltage to the fifth node in response to a bias signal and a light emitting element including a first electrode connected to the fifth node and a second electrode which receives a second power voltage. The voltage generator outputs the control signal. The control signal is a direct current (DC) voltage.

In embodiments of the disclosure, as described above, an emission transistor of a pixel circuit may be weakly turned on, such that in an emission waiting period (e.g., a holding period), a voltage change of a second node connected to a second electrode of a driving transistor may be reduced. In the holding period, the voltage change of the second node connected to the second electrode of the driving transistor may be reduced, such that a voltage change of a first node connected to a control electrode of the driving transistor by coupling of the voltage change of the second node may be reduced. Accordingly, a reliability of a driving current generated from the driving transistor may be improved, such that an emission reliability of the pixel circuit may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a circuit diagram illustrating an embodiment of a pixel circuit included in a display device of FIG. 1.

FIG. 3 is a signal timing diagram illustrating input signals applied to the pixel circuit of FIG. 2.

FIG. 4 is a circuit diagram illustrating an operation of a pixel circuit of FIG. 2 in a first period of FIG. 3.

FIG. 5 is a circuit diagram illustrating an operation of a pixel circuit of FIG. 2 in a second period of FIG. 3.

FIG. 6 is a circuit diagram illustrating an operation of a pixel circuit of FIG. 2 in a third period of FIG. 3.

FIG. 7 is a circuit diagram illustrating an operation of a pixel circuit of FIG. 2 in a fourth period of FIG. 3.

FIG. 8 is a signal timing diagram illustrating input signals applied to a pixel circuit of FIG. 2.

FIG. 9 is a circuit diagram illustrating an operation of a pixel circuit in a third period of FIG. 8.

FIG. 10 is a circuit diagram illustrating an operation of a pixel circuit in a third period of FIG. 8.

FIG. 11 is a circuit diagram illustrating an embodiment of a pixel circuit included in a display device of FIG. 1.

FIG. 12 is a signal timing diagram illustrating input signals applied to the pixel circuit of FIG. 11.

FIG. 13 is a circuit diagram illustrating an operation of a pixel circuit of FIG. 11 in a first period of FIG. 12.

FIG. 14 is a circuit diagram illustrating an operation of a pixel circuit of FIG. 11 in a second period of FIG. 12.

FIG. 15 is a circuit diagram illustrating an operation of a pixel circuit of FIG. 11 in a third period of FIG. 12.

FIG. 16 is a circuit diagram illustrating an operation of a pixel circuit of FIG. 11 in a fourth period of FIG. 12.

FIG. 17 is a diagram illustrating an embodiment of pixel of FIG. 1 disposed on a substrate.

FIG. 18 is a block diagram illustrating an electronic device according to an embodiment of the invention.

FIG. 19 is a diagram illustrating an embodiment in which the electronic device of FIG. 18 is implemented as a smart phone.

FIG. 20 is a diagram illustrating an embodiment in which the electronic apparatus of FIG. 18 is implemented as a virtual reality display system.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

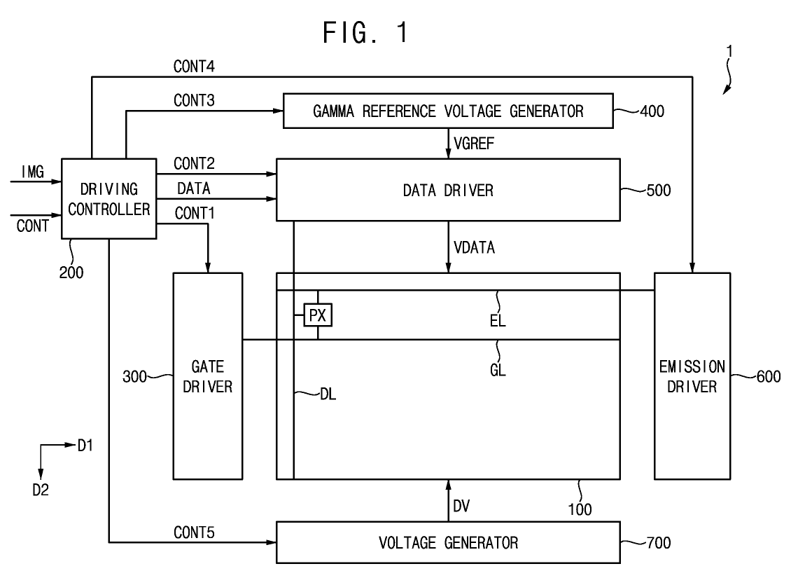

FIG. 1 is a block diagram illustrating a display device 1 according to embodiments of the invention.

Referring to FIG. 1, an embodiment of the display device 1 may include a display panel 100 and a display panel driver. In an embodiment, the display panel driver may include a driving controller 200, a gate driver 300, a gamma reference voltage generator 400, a data driver 500, an emission driver 600 and a voltage generator 700.

The display panel 100 may include a display region, on which an image is displayed, and a peripheral region adjacent to the display region.

The display panel 100 may include a plurality of gate lines GL, plurality of emission lines EL, a plurality of data lines DL and a plurality of pixel circuits PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600. The fourth control signal CONT4 may include the vertical start signal and an emission clock signal. In an embodiment, the gate clock signal and the emission clock signal may be substantially the same as each other.

The driving controller 200 may generate the fifth control signal CONT5 for controlling an operation of the voltage generator 700 based on the input control signal CONT, and output the fifth control signal CONT5 to the voltage generator 700.

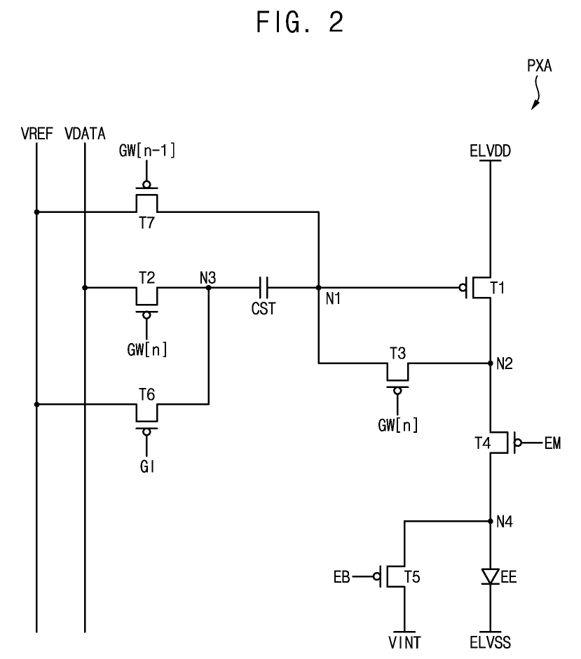

The gate driver 300 may generate gate signals driving the gate lines GL in response to the first control signal CONT1 received from the driving controller 200. The gate driver 300 may output the gate signals to the gate lines GL. The gate driver 300 may generate the gate signals based on the power voltage DV applied from the voltage generator 700. In an embodiment, for example, the gate driver 300 may generate the gate signals based on a gate high voltage and a gate low voltage. The gate driver 300 may output the gate signals to the gate lines GL. In an embodiment, for example, the gate signals may include an initialization gate signal GI of FIG. 2, a write gate signal GW[n] of FIG. 2, a previous stage write gate signal GW[n-1] and a bias signal EB of FIG. 2. In an embodiment, for example, the gate signal may toggle between a first gate voltage and a second gate voltage lower than the first gate voltage. In the disclosure, the bias signal EB may be called as a light emitting element initialization gate signal. In the disclosure, the bias signal EB may also be called as a bias gate signal.

In an embodiment, the gate driver 300 may be disposed in the peripheral region. In an embodiment, the gate driver 300 may be integrated (or integrally formed) in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

The emission driver 600 may generate emission signal EM of FIG. 2 in response to the fourth control signal CONT4 received from the driving controller 200. The emission driver 600 may output the emission signal EM of FIG. 2 to the display panel 100. The emission driver 600 may generate the emission signal EM of FIG. 2 based on the power voltage DV applied from the voltage generator 700. In an embodiment, for example, the emission driver 600 may generate the emission signal EM of FIG. 2 based on an emission high voltage and an emission low voltage. In an embodiment, the emission low voltage may be higher than the gate low voltage. In an embodiment, an activation level of the emission signal EM of FIG. 2 may be higher than an activation level of the write gate signal GW[n] of FIG. 2. In an embodiment, an absolute value of an activation level (e.g., a second emission voltage) of the emission signal EM of FIG. 2 may be lower than an absolute value of the second gate voltage.

In an embodiment, the emission driver 600 may be disposed in the peripheral region. In an embodiment, the emission driver 600 may be integrated (or integrally formed) in the peripheral region.

Although FIG. 1 shows an embodiment where the gate driver 300 is disposed on a first side of the display panel 100, and the emission driver 600 is disposed on a second side of the display panel 100 for convenience of illustration and description, the invention is not limited thereto. The gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other or integrated into a single chip.

The voltage generator 700 may output the power voltage DV in response to the fifth control signal CONT5 received from the driving controller 200. In an embodiment, for example, the power voltage DV may include a first power voltage ELVDD, a second power voltage ELVSS, the gate high voltage, the gate low voltage, the emission high voltage and the emission low voltage. The voltage generator 700 may output the power voltage to the display panel 100, the gate driver 300 and the emission driver 600.

FIG. 2 is a circuit diagram illustrating an embodiment of a pixel circuit PX included in a display device 1 of FIG. 1.

Referring to FIG. 1 and FIG. 2, an embodiment of the pixel circuit PXA may include a first transistor T1, a second transistor T2, a third transistor T3, a fourth transistor T4, a fifth transistor T5, a sixth transistor T6, a seventh transistor T7, a storage capacitor CST and a light emitting element EE.

The first transistor T1 may include a control electrode connected to a first node N1, a first electrode that receives a first power voltage ELVDD and a second electrode connected to a second node N2. The first transistor T1 may generate a driving current based on a voltage of the first node N1. The first transistor T1 may apply the driving current to the second node N2 in response to the voltage of the first node N1. In the disclosure, the first transistor T1 may be called as a driving transistor.

The second transistor T2 may include a control electrode that receives a write gate signal GW[n], a first electrode that receives the data voltage VDATA and a second electrode connected to a third node N3. The second transistor T2 may apply the data voltage VDATA to the third node N3 in response to the write gate signal GW[n]. In the disclosure, the second transistor T2 may be called as a write transistor.

The third transistor T3 may include a control electrode that receives the write gate signal GW[n], a first electrode connected to the second node N2 and a second electrode connected to the first node N1. The third transistor T3 may connect the first node N1 and the second node N2 to each other in response to the write gate signal GW[n]. The third transistor T3 may be diode-connecting the first transistor T1 in response to the write gate signal GW[n]. In the disclosure, the third transistor T3 may be called as a compensation transistor.

The fourth transistor T4 may include a control electrode that receives the emission signal EM, a first electrode connected to the second node N2 and a second electrode connected to a fourth node N4. The fourth transistor T4 may connect the second node N2 and the fourth node N4 to each other in response to the emission signal EM. The fourth transistor T4 may apply the driving current to the fourth node N4 in response to the emission signal EM. In the disclosure, the fourth transistor T4 may be called as an emission transistor.

The fifth transistor T5 may include a control electrode that receives the bias signal EB, a first electrode connected to the fourth node N4 and a second electrode that receives an initialization voltage VINT. The fifth transistor T5 may apply the initialization voltage VINT to the fourth node N4 in response to the bias signal EB. In the disclosure, the fifth transistor may be called as a light emitting element initialization transistor.

In an embodiment, the initialization voltage VINT may be lower than a second power voltage ELVSS. In an embodiment, for example, the initialization voltage VINT may be lower than a value obtained by subtracting the absolute value of the threshold voltage of the fifth transistor T5 from the value obtained by adding the second power voltage ELVSS and the threshold voltage of the light emitting element EE. Accordingly, when the initialization voltage VINT is applied to the fourth node N4, the light emitting element EE may not emits light. In an embodiment, for example, when the initialization voltage VINT is applied to the fourth node N4, the pixel circuit PXA may display black. The initialization voltage VINT may be lower than the second power voltage ELVSS, such that a black characteristic of the pixel circuit PXA may be improved.

The sixth transistor T6 may include a control electrode that receives the initialization gate signal GI, a first electrode that receives a reference voltage VREF and a second electrode connected to the third node N3. The sixth transistor T6 may apply the reference voltage VREF to the third node N3 in response to the initialization gate signal GI. In the disclosure, the sixth transistor T6 may be called as a first initialization transistor.

The seventh transistor T7 may include a control electrode that receives the previous stage gate signal GW[n-1], a first electrode that receives the reference voltage VREF and the second electrode connected to the first node N1. The seventh transistor T7 may apply the reference voltage VREF to the third node N3 in response to the previous stage write gate signal GW[n-1]. In the disclosure, the seventh transistor T7 may be called as a second initialization transistor.

The storage capacitor CST may include a first electrode connected to the third node N3 and a second electrode connected to the first node N1. The storage capacitor CST may store a difference (or electric potential) between a voltage of the first node N1 and a voltage of the third node N3. The storage capacitor CST may be coupling a change of the voltage of the third node N3 and apply a coupling voltage to the first node N1. In the disclosure, the storage capacitor CST may be called as a first storage capacitor.

The light emitting element EE may include a first electrode connected to the fourth node N4 and the second electrode that receives the second power voltage ELVSS. In an embodiment, the light emitting element EE may include an organic light emitting diode (OLED), a nano light emitting diode (NED), a quantum dot (QD) light emitting diode, a micro light emitting diode, an inorganic light emitting diode, or any other suitable light emitting element.

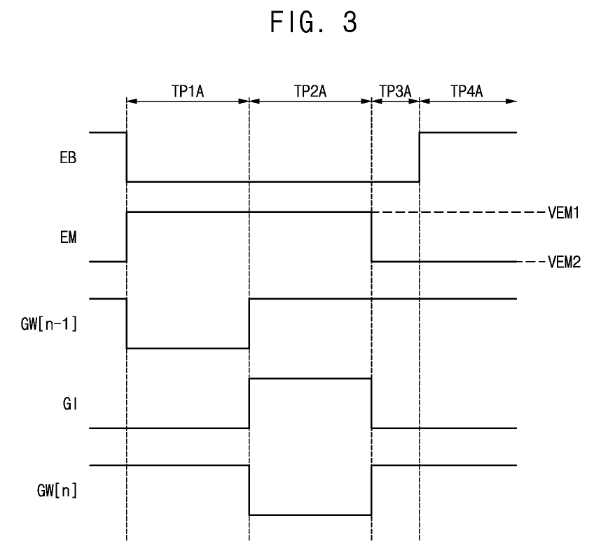

FIG. 3 is a signal timing diagram illustrating input signals applied to the pixel circuit PXA of FIG. 2.

Referring to FIG. 1 to FIG. 3, a frame period during which the pixel circuit PXA is driven may include a first period TP1A, a second period TP2A, a third period TP3A and a fourth period TP4A.

In the first period TP1A, the bias signal EB may have an activation level, the emission signal EM may have an inactivation level, the previous stage gate signal GW[n-1] may have an activation level, the initialization gate signal GI may have an activation level and the write gate signal GW[n] may have an inactivation level. In the disclosure, the first period TP1A may be called as an initialization period.

In the second period TP2A, the bias signal EB may have an activation level, the emission signal EM may have an inactivation level, the previous stage gate signal GW[n-1] may have an inactivation level, the initialization gate signal GI may have an inactivation level and the write gate signal GW[n] may have an activation level. In the disclosure, the second period TP2A may be called as a data writing period.

In the third period TP3A, the bias signal EB may have an activation level, the emission signal EM may have an activation level, the previous stage gate signal GW[n-1] may have an inactivation level, the initialization gate signal GI may have an activation level and the write gate signal GW[n] may have an inactivation level. In the disclosure, the third period TP3A may be called as a holding period.

In the fourth period TP4A, the bias signal EB may have an inactivation level, the emission signal EM may have an activation level, the previous stage gate signal GW[n-1] may have an inactivation level, the initialization gate signal GI may have an activation level and the write gate signal GW[n] may have an inactivation level. In the disclosure, the fourth period TP4A may be called as an emitting period.

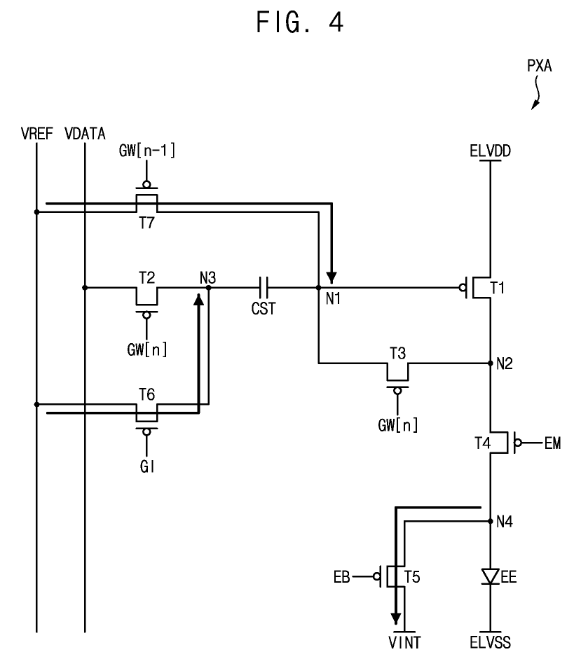

FIG. 4 is a circuit diagram illustrating an operation of a pixel circuit PXA of FIG. 2 in a first period TP1A of FIG. 3.

Referring to FIG. 3 and FIG. 4, in the first period TP1A, the sixth transistor T6 may be turned on based on the initialization gate signal GI. The sixth transistor T6 may be turned on, such that the reference voltage VREF may be applied to the third node N3. The seventh transistor T7 may be turned on in response to the previous stage write gate signal GW[n-1]. The seventh transistor T7 may be turned on in the first period TP1A, such that the reference voltage VREF may be applied to the first node N1. In an embodiment, for example, the first node N1 may be initialized as the reference voltage VREF. In an embodiment, for example, the third node N3 may be initialized as the reference voltage VREF. The first node N1 may receive the reference voltage VREF and the third node N3 may receive the reference voltage VREF, such that a voltage of the first node N1 and a voltage of the third node N3 may be substantially the same as each other. Accordingly, the storage capacitor CST may be initialized.

In the first period TP1A, the first transistor T1 may be turned on in response to a voltage of the first node N1.

In the first period TP1A, the fifth transistor T5 may be turned on in response to the bias signal EB. The fifth transistor T5 may be turned on in the first period TP1A, such that the initialization voltage VINT may be applied to the fourth node N4. The initialization voltage VINT may be applied to the fourth node N4 in the first period TP1A, such that the light emitting element EE may stop emitting light.

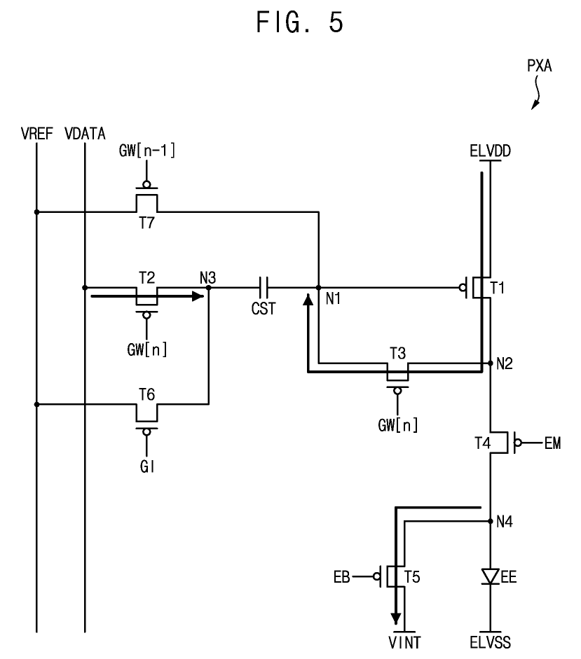

FIG. 5 is a circuit diagram illustrating an operation of a pixel circuit PXA of FIG. 2 in a second period TP2A of FIG. 3.

Referring to FIG. 3 and FIG. 5, in the second period TP2A, the second transistor T2 may be turned on in response to the write gate signal GW[n]. The second transistor T2 may be turned on in the second period TP2A, such that the data voltage VDATA may be applied to the third node N3.

In the second period TP2A, the third transistor T3 may be turned on in response to the write gate signal GW[n]. The third transistor T3 may be turned on in the second period TP2A, such that the first transistor T1 may be diode-connected. The first transistor T1 may be diode-connected (or connected in a diode form) in the second period TP2A, such that a voltage which is a sum of the threshold voltage of the first transistor T1 and the first power voltage ELVDD may be applied to the first node N1. In the disclosure, the sum of the threshold voltage of the first transistor T1 and the first power voltage ELVDD may be called as a compensation voltage. The storage capacitor CST may store a difference between the data voltage VDATA and the compensation voltage.

In an embodiment, the first electrode of the first transistor T1 may be a source electrode. In such an embodiment, the data voltage VDATA may not be applied through the source electrode of the first transistor T1. The source electrode of the first transistor T1 may receive the first power voltage ELVDD. In an embodiment, for example, the source electrode of the first transistor T1 may only receive the first power voltage ELVDD. Accordingly, a voltage applied to the source electrode of the first transistor T1 may not be changed. The voltage applied to the source electrode of the first transistor T1 may not be changed, such that a change of the threshold voltage of the first transistor T1 by the body effect may not occur. In such an embodiment, the threshold voltage of the first transistor T1 may be substantially constant during the frame period. Accordingly, the accuracy of the compensation voltage may be improved. the accuracy of the compensation voltage may be improved, such that the driving reliability and the emitting reliability may be further improved.

In the second period TP2A, a turn-on state of the fifth transistor T5 may be maintained in response to the bias signal EB having an inactivation level.

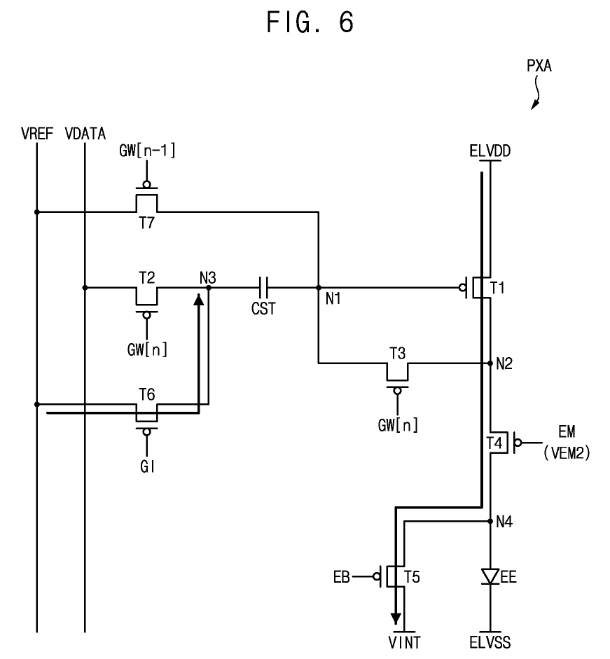

FIG. 6 is a circuit diagram illustrating an operation of a pixel circuit PXA of FIG. 2 in a third period TP3A of FIG. 3.

Referring to FIG. 3 and FIG. 6, in the third period TP3A, the sixth transistor T6 may be turned on in response to the initialization gate signal GI. The sixth transistor T6 may be turned on in the third period TP3A, such that the reference voltage VREF may be applied to the third node N3. The third transistor T3 may be turned off in response to the write gate signal GW[n]. The third transistor T3 may be turned off in the third period TP3A, such that the first node N1 may be floating or in a floated state. The storage capacitor CST may be coupling a change of a voltage of the third node N3. The storage capacitor CST may be coupling the change of the voltage of the third node N3 and apply a coupling voltage to the first node N1. The coupling voltage may be applied to the first node N1 in the third period TP3A, such that the first node N1 may have a voltage considering the compensation voltage and the data voltage VDATA.

In the third period TP3A, the first transistor T1 may generate the driving current based on a voltage of the first node N1.

In the third period TP3A, the fourth transistor T4 may be turned on in response to the emission signal EM. In the third period TP3A, the turn-on state of the fifth transistor T5 may be maintained in response to the bias gate signal EB. Accordingly, the light emitting element EE may not emit light.

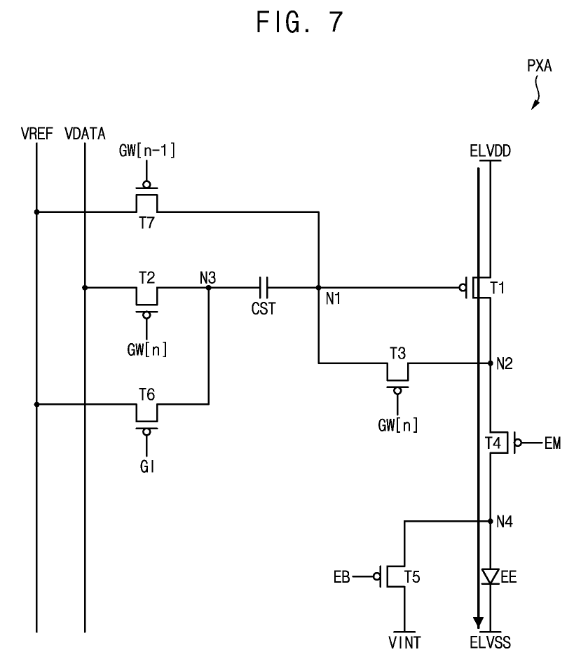

FIG. 7 is a circuit diagram illustrating an operation of a pixel circuit PXA of FIG. 2 in a fourth period TP4A of FIG. 3.

Referring to FIG. 3 and FIG. 7, in the fourth period TP4A, the fifth transistor T5 may be turned off in response to the bias signal EB. Accordingly, the driving current may be applied to the light emitting element EE. In the fourth period TP4A, the light emitting element EE may emit light based on the driving current.

Referring to FIG. 1 to FIG. 7, in an emission period of a conventional pixel circuit, the reliability of the current applied to the conventional light emitting element included in the conventional pixel circuit may be deteriorated by the parasitic capacitance of at least one of transistors included in the conventional pixel circuit in an emitting period. For example, when the conventional pixel circuit displays black, a current may be applied to the conventional light emitting element by the parasitic capacitance. Accordingly, the conventional light emitting element may emit light. When the conventional pixel circuit displays black, the conventional light emitting element may emit light, such that the display quality is reduced.

In an embodiment of the invention, the frame period during which the pixel circuit PXA is driven may include a third period TP3A. In the third period TP3A, a current may flow along a path through the first transistor T1, the fourth transistor T4 and the fifth transistor T5. Accordingly, the influence of the parasitic capacitance in the emitting period may be reduced. In an embodiment, for example, when the pixel circuit PXA displays black, the influence of the parasitic capacitance is reduced, such that the light emitting element EE may not emit light. Accordingly, the emitting reliability of the pixel circuit PXA may be improved, such that the display quality of the display panel 100 may be improved.

In an embodiment, as shown in FIG. 3, an inactivation level of the emission signal EM may have a first emission voltage VEM1, and an activation level of the emission signal may have a second emission voltage VEM2 lower than the first emission voltage VEM1. In an embodiment, for example, the emission high voltage may correspond to the first emission voltage VEM1. In an embodiment, for example, the emission low voltage may correspond to the second emission voltage VEM2. The second emission VEM2 may be set based on a driving voltage of the light emitting element EE. The second emission voltage VEM2 may be set based on a source-drain voltage of the driving transistor. The driving voltage of the light emitting element EE may mean a voltage applied to the first electrode (e.g., anode) of the light emitting element EE based on the driving current. In an embodiment, for example, the second emission voltage VEM2 may be set to a value obtained by subtracting a threshold voltage of the fourth transistor T4 from a value obtained by adding the second power voltage ELVSS and the driving voltage. In an embodiment, for example, the second emission voltage VEM2 may be set to a voltage (e.g., a low limit voltage) higher than a value obtained by subtracting the threshold voltage of the fourth transistor T4 from the value obtained by adding the second power voltage ELVSS and the driving voltage. In an embodiment, for example, an absolute value of the second emission voltage VEM2 may be smaller than a value obtained by subtracting an absolute value of the threshold voltage of the fourth transistor T4 from a value obtained by adding the voltage of the second electrode of the driving transistor and the second power voltage ELVSS. In an embodiment, for example, the second emission voltage VEM2 may be a voltage obtained by subtracting the threshold voltage of the fourth transistor T4 from the first emission voltage VEM1. In an embodiment, for example, the second emission voltage VEM2 may be set to a voltage (e.g., an upper limit voltage) lower than a value obtained by subtracting the source-drain voltage of the first transistor T1 and the threshold voltage of the fourth transistor T4 from the first power voltage ELVDD. In an embodiment, for example, the second emission voltage VEM2 may be set to a voltage between the low limit voltage and the upper limit voltage.

Accordingly, in an embodiment, the control electrode of the fourth transistor T4 of the pixel circuit PXA may receive the emission signal EM having an activation level higher than an activation level of an emission signal applied to an emission signal included in a conventional pixel circuit. In an embodiment, for example, the absolute value of the second voltage VEM2 of the emission signal EM may be lower than a voltage corresponding to an activation level of the emission signal applied to the emission transistor of the conventional pixel circuit. Accordingly, the fourth transistor T4 may be weakly turned on or in a weak turn-on state.

In the holding period, the initialization voltage VINT may be applied to the second node, such that the first node N1 may be coupled by a voltage change of the second node N2. Accordingly, a voltage of the first node N1 may be changed. In the holding period, when the voltage of the first node N1 is changed, a reliability of the driving current may be deteriorated, such that an emission reliability of the pixel circuit may be deteriorated.

In an embodiment, the fourth transistor T4 may be weakly turned on in the holding period, such that the voltage changed of the second node N2 may be reduced. In the holding period, the voltage changed of the second node N2 may be reduced, such that a voltage change of the first node N1 by coupling of the voltage change of the second node N2 may be reduced. Accordingly, a reliability of the driving current may be improved, such that an emission reliability of the pixel circuit PXA may be improved.

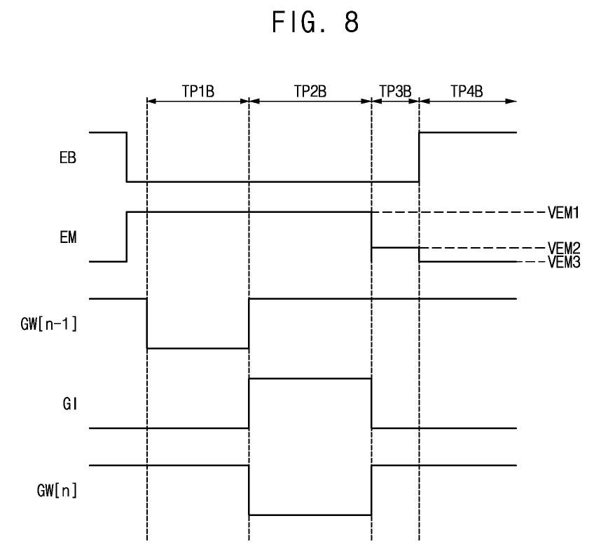

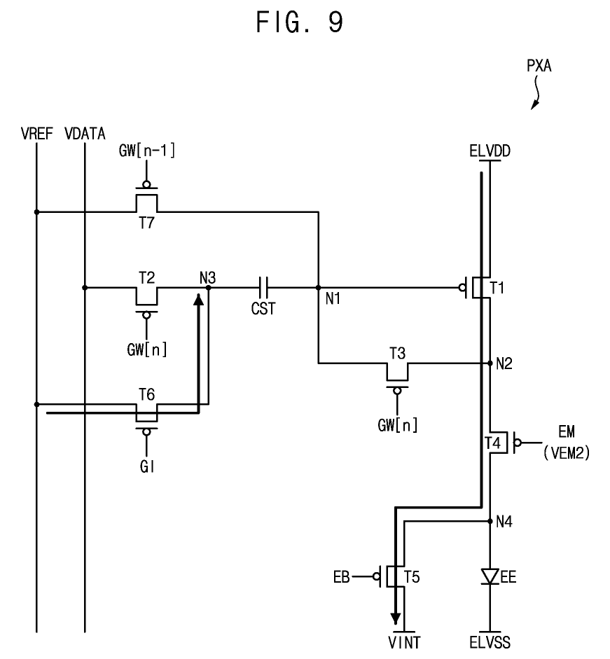

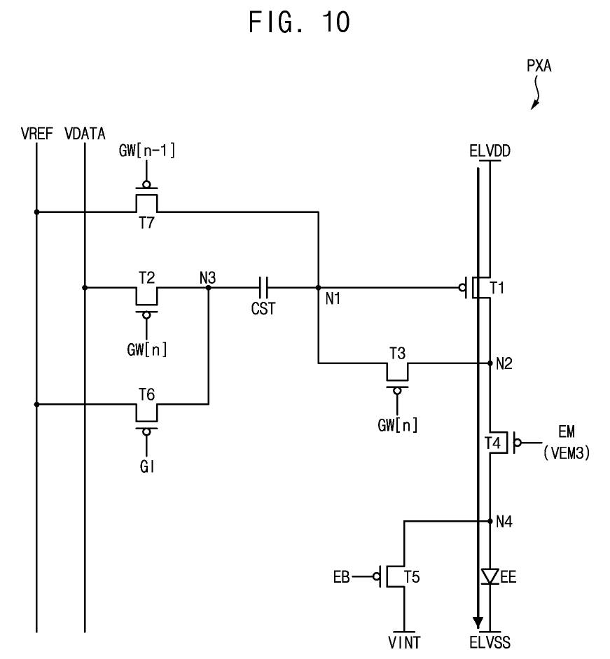

FIG. 8 is a signal timing diagram illustrating input signals applied to a pixel circuit PXA of FIG. 2. FIG. 9 is a circuit diagram illustrating an operation of a pixel circuit PXA in a third period TP3B of FIG. 8. FIG. 10 is a circuit diagram illustrating an operation of a pixel circuit PXA in a third period TP3B of FIG. 8.

Referring to FIG. 1, FIG. 2 and FIG. 10, a frame period during which the pixel circuit PXA is driven may include a first period TP1B, a second period TP2B, a third period TP3B and a fourth period TP4B.

In the first period TP1B, the bias signal EB may have an activation level, the emission signal EM may have the first emission voltage VEM1, the previous stage gate signal GW[n-1] may have an activation level, the initialization gate signal GI may have an activation level and the write gate signal GW[n] may have an inactivation level. In the disclosure, the first period TP1A may be called as the initialization period.

In the second period TP2B, the bias signal EB may have an activation level, the emission signal EM may have the first emission voltage VEM1, the previous stage gate signal GW[n-1] may have an inactivation level, the initialization gate signal GI may have an inactivation level and the write gate signal GW[n] may have an activation level. In the disclosure, the second period TP2B may be called as the data writing period.

In the third period TP3B, the bias signal EB may have an activation level, the emission signal EM may have the second emission voltage VEM2, the previous stage gate signal GW[n-1] may have an inactivation level, the initialization gate signal GI may have an activation level and the write gate signal GW[n] may have an inactivation level. In the disclosure, the third period TP3B may be called as the holding period.

In the fourth period TP4B, the bias signal EB may have an inactivation level, the emission signal EM may have the third emission voltage VEM2, the previous stage gate signal GW[n-1] may have an inactivation level, the initialization gate signal GI may have an activation level and the write gate signal GW[n] may have an inactivation level. The third emission voltage VEM3 may be lower than the second emission voltage VEM2. In the disclosure, the fourth period TP4B may be called as an emitting period.

In an emission period of a conventional pixel circuit, the reliability of the current applied to the conventional light emitting element included in the conventional pixel circuit may be deteriorated by the parasitic capacitance of at least one of transistors included in the conventional pixel circuit in an emitting period. For example, when the conventional pixel circuit displays black, a current may be applied to the conventional light emitting element by the parasitic capacitance. Accordingly, the conventional light emitting element may emit light. When the conventional pixel circuit displays black, the conventional light emitting element may emit light, such that the display quality is reduced.

In an embodiment of the invention, the frame period during which the pixel circuit PXA is driven may include a third period TP3B. In the third period TP3B, a current may flow along a path through the first transistor T1, the fourth transistor T4 and the fifth transistor T5. Accordingly, the influence of the parasitic capacitance in the emitting period may be reduced. In an embodiment, for example, when the pixel circuit PXA displays black, the influence of the parasitic capacitance is reduced, such that the light emitting element EE may not emit light. Accordingly, the emitting reliability of the pixel circuit PXA may be improved, such that the display quality of the display panel 100 may be improved.

In an embodiment, in the third period TP3B, when the current flows along a path through the first transistor T1, the fourth transistor T4 and the fifth transistor T5, and the fifth transistor T5 may be weakly turned on, the leakage current may be further reduced. Accordingly, a display quality of the display panel 100 may be further improved.

In an embodiment, an inactivation level of the emission signal EM may have a first emission voltage VEM1, and an activation level of the emission signal may have a second emission voltage VEM2 lower than the first emission voltage VEM1. In an embodiment, for example, the emission high voltage may correspond to the first emission voltage VEM1. In an embodiment, for example, the emission low voltage may correspond to the second emission voltage VEM2. The second emission VEM2 may be set based on a driving voltage of the light emitting element EE. The second emission voltage VEM2 may be set based on a source-drain voltage of the driving transistor. The driving voltage of the light emitting element EE may mean a voltage applied to the first electrode (e.g., anode) of the light emitting element EE based on the driving current. In an embodiment, for example, the second emission voltage VEM2 may be set to a value obtained by subtracting a threshold voltage of the fourth transistor T4 from a value obtained by adding the second power voltage ELVSS and the driving voltage. In an embodiment, for example, the second emission voltage VEM2 may be set to a voltage (e.g., a low limit voltage) higher than a value obtained by subtracting the threshold voltage of the fourth transistor T4 from the value obtained by adding the second power voltage ELVSS and the driving voltage. In an embodiment, for example, an absolute value of the second emission voltage VEM2 may be smaller than a value obtained by subtracting an absolute value of the threshold voltage of the fourth transistor T4 from a value obtained by adding the voltage of the second electrode of the driving transistor and the second power voltage ELVSS. In an embodiment, for example, the second emission voltage VEM2 may be a voltage obtained by subtracting the threshold voltage of the fourth transistor T4 from the first emission voltage VEM1. In an embodiment, for example, the second emission voltage VEM2 may be set to a voltage (e.g., an upper limit voltage) lower than a value obtained by subtracting the source-drain voltage of the first transistor T1 and the threshold voltage of the fourth transistor T4 from the first power voltage ELVDD. In an embodiment, for example, the second emission voltage VEM2 may be set to a voltage between the low limit voltage and the upper limit voltage.

Accordingly, in an embodiment, the control electrode of the fourth transistor T4 of the pixel circuit PXA may receive the emission signal EM having an activation level higher than an activation level of an emission signal applied to an emission signal included in a conventional pixel circuit. In an embodiment, for example, the absolute value of the second voltage VEM2 of the emission signal EM may be lower than a voltage corresponding to an activation level of the emission signal applied to the emission transistor of the conventional pixel circuit. Accordingly, the fourth transistor T4 may be weakly turned on.

In the holding period, the initialization voltage VINT may be applied to the second node, such that the first node N1 may be coupled by a voltage change of the second node N2. Accordingly, a voltage of the first node N1 may be changed. In the holding period, when the voltage of the first node N1 is changed, a reliability of the driving current may be deteriorated, such that an emission reliability of the pixel circuit may be deteriorated.

In an embodiment, the fourth transistor T4 may be weakly turned on in the holding period, such that the voltage changed of the second node N2 may be reduced. In the holding period, the voltage changed of the second node N2 may be reduced, such that a voltage change of the first node N1 by coupling of the voltage change of the second node N2 may be reduced. Accordingly, a reliability of the driving current may be improved, such that an emission reliability of the pixel circuit PXA may be improved.

In an embodiment, in the fourth period TP4B, the emission signal EM may have the third emission voltage VEM3 lower than the second emission voltage VEM2. The emission signal EM may have the third emission voltage VEM3, such that the fourth transistor T4 may be fully turned on. In the fourth period TP4B, the fourth transistor T4 may be fully turned on, such that a reliability of the driving current outputted in the fourth period TP4B may be further improved.

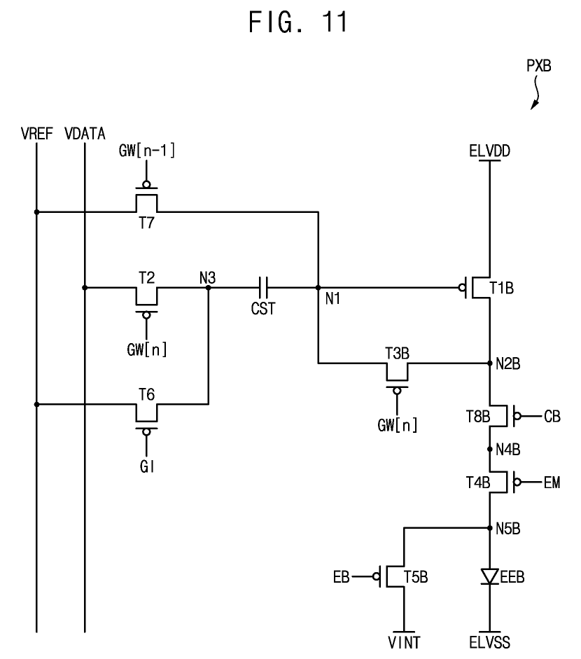

FIG. 11 is a circuit diagram illustrating an embodiment of a pixel circuit PX included in a display device 1 of FIG. 1.

Referring to FIG. 1 and FIG. 11, an embodiment of a pixel circuit PXB may include a first transistor T1B, the second transistor T2, the third transistor T3, a fourth transistor T4B, a fifth transistor T5B, the sixth transistor T6, a seventh transistor T7, an eighth transistor T8B, the storage capacitor CST and a light emitting element EEB.

The first transistor T1B may include a control electrode connected to a first node N1, a first electrode that receives a first power voltage ELVDD and a second electrode connected to a second node N2B. The first transistor T1B may generate a driving current based on a voltage of the first node N1. The first transistor T1B may apply the driving current to the second node N2B in response to the voltage of the first node N1. In the disclosure, the first transistor T1B may be called as the driving transistor.

The second transistor T2 may include a control electrode that receives a write gate signal GW[n], a first electrode that receives the data voltage VDATA and a second electrode connected to a third node N3. The second transistor T2 may apply the data voltage VDATA to the third node N3 in response to the write gate signal GW[n]. In the disclosure, the second transistor T2 may be called as the write transistor.

The third transistor T3B may include a control electrode that receives the write gate signal GW[n], a first electrode connected to the second node N2B and a second electrode connected to the first node N1. The third transistor T3B may connect the first node N1 and the second node N2B to each other in response to the write gate signal GW[n]. The third transistor T3B may be diode-connecting the first transistor T1B in response to the write gate signal GW[n]. In the disclosure, the third transistor T3B may be called as the compensation transistor.

The fourth transistor T4B may include a control electrode that receives the emission signal EM, a first electrode connected to the fourth node N4B and a second electrode connected to a fifth node N5B. The fourth transistor T4B may connect the fourth node N4B and the fifth node N5B to each other in response to the emission signal EM. The fourth transistor T4B may apply the driving current to the fifth node N5B in response to the emission signal EM. In the disclosure, the fourth transistor T4B may be called as the emission transistor.

The fifth transistor T5B may include a control electrode that receives the bias signal EB, a first electrode connected to the fifth node N5B and a second electrode that receives an initialization voltage VINT. The fifth transistor T5B may apply the initialization voltage VINT to the fifth node N5B in response to the bias signal EB. In the disclosure, the fifth transistor T5B may be called as the light emitting element initialization transistor.

In an embodiment, the initialization voltage VINT may be lower than a second power voltage ELVSS. In an embodiment, for example, the initialization voltage VINT may be lower than a value obtained by subtracting the absolute value of the threshold voltage of the fifth transistor T5B from the value obtained by adding the second power voltage ELVSS and the threshold voltage of the light emitting element EE. Accordingly, when the initialization voltage VINT is applied to the fifth node N5B, the light emitting element EE may not emits light. In an embodiment, for example, when the initialization voltage VINT is applied to the fifth node N5B, the pixel circuit PXA may display black. The initialization voltage VINT may be lower than the second power voltage ELVSS, such that a black characteristic of the pixel circuit PXA may be improved.

The sixth transistor T6 may include a control electrode that receives the initialization gate signal GI, a first electrode that receives a reference voltage VREF and a second electrode connected to the third node N3. The sixth transistor T6 may apply the reference voltage VREF to the third node N3 in response to the initialization gate signal GI. In the disclosure, the sixth transistor T6 may be called as the first initialization transistor.

The seventh transistor T7 may include a control electrode that receives the previous stage gate signal GW[n-1], a first electrode that receives the reference voltage VREF and the second electrode connected to the first node N1. The seventh transistor T7 may apply the reference voltage VREF to the third node N3 in response to the previous stage write gate signal GW[n-1]. In the disclosure, the seventh transistor T7 may be called as the second initialization transistor.

The eighth transistor T8B may include a control electrode that receives a control signal CB, a first electrode connected to the second node N2B and a second electrode connected to the fourth node N4B. The eighth transistor T8B may connect the second node N2B and the fourth node N4B to each other in response to the control signal CB. In the disclosure, the eighth transistor T8B may be called as a control transistor.

The control signal CB may be a direct current (DC) voltage which is a control voltage. The control voltage may be a voltage that allows the eighth transistor T8B to be turned on. In an embodiment, the control voltage may be a voltage that allows the eighth transistor T8B to be weakly turned on.

The storage capacitor CST may include a first electrode connected to the third node N3 and a second electrode connected to the first node N1. The storage capacitor CST may store a difference between a voltage of the first node N1 and a voltage of the third node N3. The storage capacitor CST may be coupling a change of the voltage of the third node N3 and apply a coupling voltage to the first node N1. In the disclosure, the storage capacitor CST may be called as a first storage capacitor.

The light emitting element EEB may include a first electrode connected to the fifth node N5B and the second electrode that receives the second power voltage ELVSS. In an embodiment, the light emitting element EEB may include an organic light emitting diode (OLED), a nano light emitting diode (NED), a quantum dot (QD) light emitting diode, a micro light emitting diode, an inorganic light emitting diode, or any other suitable light emitting element.

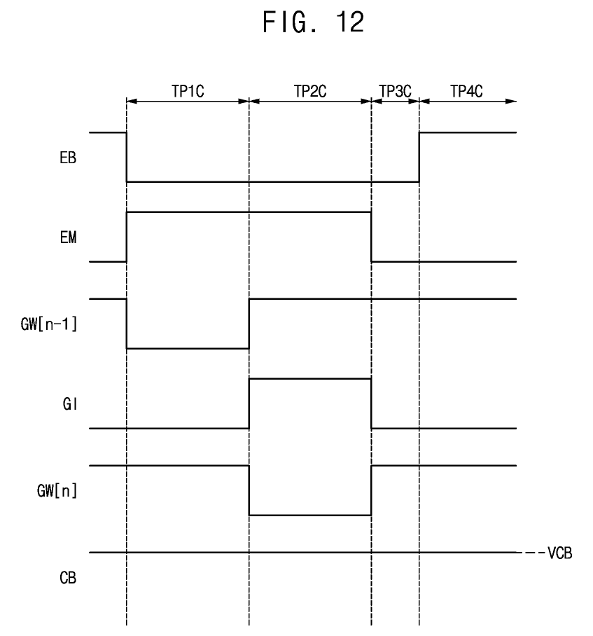

FIG. 12 is a signal timing diagram illustrating input signals applied to the pixel circuit PXB of FIG. 11.

Referring to FIG. 1, FIG. 11 and FIG. 12, a frame period during which the pixel circuit PXB is driven may include a first period TP1C, a second period TP2C, a third period TP3C and a fourth period TP4C.

In the first period TP1C, the bias signal EB may have an activation level, the emission signal EM may have an inactivation level, the previous stage gate signal GW[n-1] may have an activation level, the initialization gate signal GI may have an activation level, the write gate signal GW[n] may have an inactivation level, and the control signal CB may have the control voltage VCB. In the disclosure, the first period TP1C may be called as the initialization period.

In the second period TP2C, the bias signal EB may have an activation level, the emission signal EM may have an inactivation level, the previous stage gate signal GW[n-1] may have an inactivation level, the initialization gate signal GI may have an inactivation level, the write gate signal GW[n] may have an activation level, and the control signal CB may have the control voltage VCB. In the disclosure, the second period TP2C may be called as the data writing period.

In the third period TP3C, the bias signal EB may have an activation level, the emission signal EM may have an activation level, the previous stage gate signal GW[n-1] may have an inactivation level, the initialization gate signal GI may have an activation level, the write gate signal GW[n] may have an inactivation level, and the control signal CB may have the control voltage VCB. In the disclosure, the third period TP3A may be called as the holding period.

In the fourth period TP4C, the bias signal EB may have an inactivation level, the emission signal EM may have an activation level, the previous stage gate signal GW[n-1] may have an inactivation level, the initialization gate signal GI may have an activation level, the write gate signal GW[n] may have an inactivation level, and the control signal CB may have the control voltage VCB. In the disclosure, the fourth period TP4A may be called as the emitting period.

In an embodiment, during the first to fourth periods TP1C, TP2C, TP3C and TP4C, the control signal CB may have the control voltage VCB, which is a constant DC voltage. Accordingly, during the frame period, the eighth transistor T8B may be turned on. In an embodiment, during the frame period, the eighth transistor T8B may be weakly turned on.

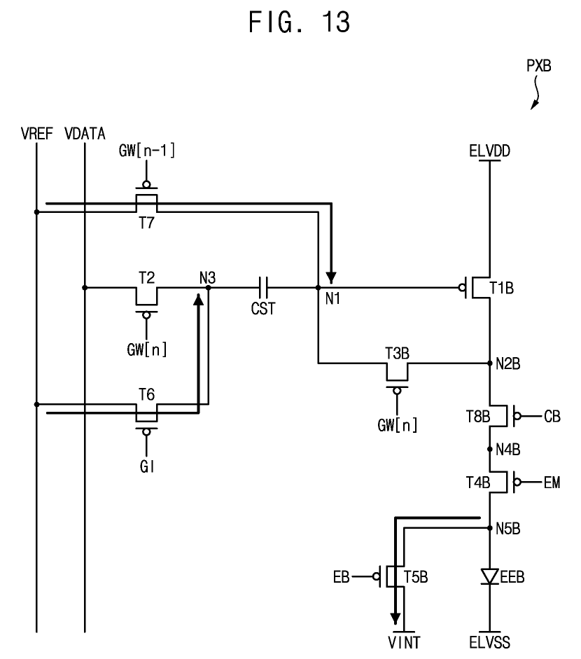

FIG. 13 is a circuit diagram illustrating an operation of a pixel circuit PXB of FIG. 11 in a first period TP1C of FIG. 12.

Referring to FIG. 12 and FIG. 13, in the first period TP1C, the sixth transistor T6 may be turned on based on the initialization gate signal GI. The sixth transistor T6 may be turned on in the first period TP1C, such that the reference voltage VREF may be applied to the third node N3. The seventh transistor T7 may be turned on in response to the previous stage write gate signal GW[n-1]. The seventh transistor T7 may be turned on in the first period TP1C, such that the reference voltage VREF may be applied to the first node N1. In an embodiment, for example, the first node N1 may be initialized as the reference voltage VREF. In an embodiment, for example, the third node N3 may be initialized as the reference voltage VREF. The first node N1 may receive the reference voltage VREF and the third node N3 may receive the reference voltage VREF in the first period TP1C, such that a voltage of the first node N1 and a voltage of the third node N3 may be substantially the same as each other. Accordingly, the storage capacitor CST may be initialized.

In the first period TP1C, the first transistor T1B may be turned on in response to a voltage of the first node N1.

In the first period TP1C, the fifth transistor T5B may be turned on in response to the bias signal EB. The fifth transistor T5B may be turned on in the first period TP1C, such that the initialization voltage VINT may be applied to the fifth node N5B. The initialization voltage VINT may be applied to the fifth node N5B in the first period TP1C, such that the light emitting element EE may stop emitting light.

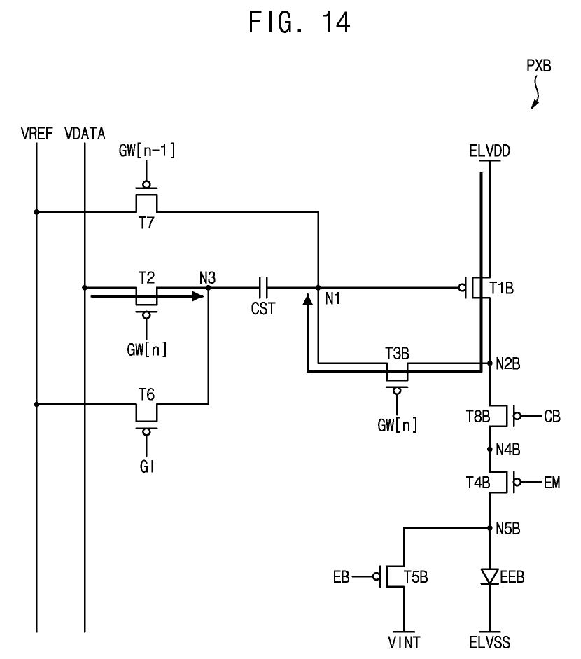

FIG. 14 is a circuit diagram illustrating an operation of a pixel circuit PXB of FIG. 11 in a second period TP2C of FIG. 12.

Referring to FIG. 12 and FIG. 14, in the second period TP2C, the second transistor T2 may be turned on in response to the write gate signal GW[n]. The second transistor T2 may be turned on in the second period TP2C, such that the data voltage VDATA may be applied to the third node N3.

In the second period TP2C, the third transistor T3B may be turned on in response to the write gate signal GW[n]. The third transistor T3B may be turned on in the second period TP2C, such that the first transistor T1B may be diode-connected. The first transistor T1B may be diode-connected in the second period TP2C, such that a voltage which is a sum of the threshold voltage of the first transistor T1B and the first power voltage ELVDD may be applied to the first node N1. In the disclosure, the sum of the threshold voltage of the first transistor T1B and the first power voltage ELVDD may be called as a compensation voltage. The storage capacitor CST may store a difference between the data voltage VDATA and the compensation voltage.

In an embodiment, the first electrode of the first transistor T1B may be a source electrode. In such an embodiment, the data voltage VDATA may not be applied through the source electrode of the first transistor T1B. The source electrode of the first transistor T1B may receive the first power voltage ELVDD. In an embodiment, for example, the source electrode of the first transistor T1B may only receive the first power voltage ELVDD. Accordingly, a voltage applied to the source electrode of the first transistor T1B may not be changed. The voltage applied to the source electrode of the first transistor T1B may not be changed, such that a change of the threshold voltage of the first transistor T1B by the body effect may not occur. Additionally, the threshold voltage of the first transistor T1B may be substantially constant during the frame period. Accordingly, the accuracy of the compensation voltage may be improved, such that the driving reliability and the emitting reliability may be further improved.

In the second period TP2C, a turn-on state of the fifth transistor T5B may be maintained in response to the bias signal EB having an inactivation level.

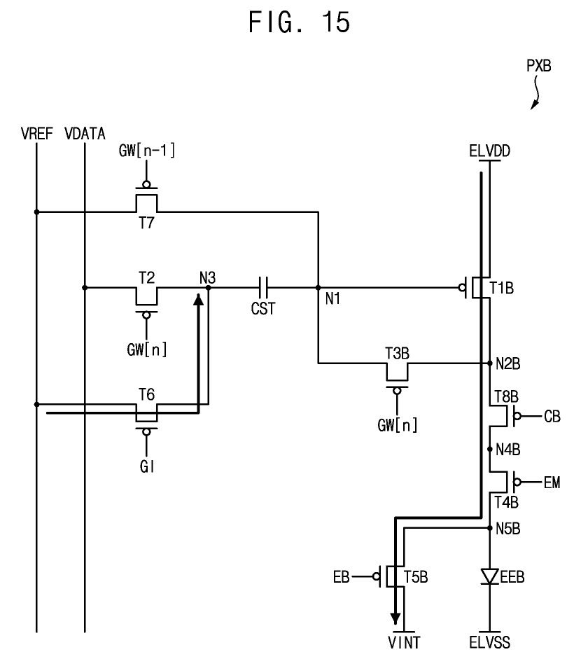

FIG. 15 is a circuit diagram illustrating an operation of a pixel circuit PXB of FIG. 11 in a third period TP3C of FIG. 12.

Referring to FIG. 12 and FIG. 15, in the third period TP3C, the sixth transistor T6 may be turned on in response to the initialization gate signal GI. The sixth transistor T6 may be turned on, such that the reference voltage VREF may be applied to the third node N3. The third transistor T3B may be turned off in response to the write gate signal GW[n]. The third transistor T3B may be turned off in the third period TP3C, such that the first node N1 may be floating. The storage capacitor CST may be coupling a change of a voltage of the third node N3. The storage capacitor CST may be coupling the change of the voltage of the third node N3 and apply a coupling voltage to the first node N1. The coupling voltage may be applied to the first node N1 in the third period TP3C, such that the first node N1 may have a voltage considering the compensation voltage and the data voltage VDATA.

In the third period TP3C, the first transistor T1B may generate the driving current based on a voltage of the first node N1.

In the third period TP3C, the fourth transistor T4B may be turned on in response to the emission signal EM. Additionally, the turn-on state of the fifth transistor T5B may be maintained in response to the bias gate signal EB. Accordingly, the light emitting element EE may not emit light.

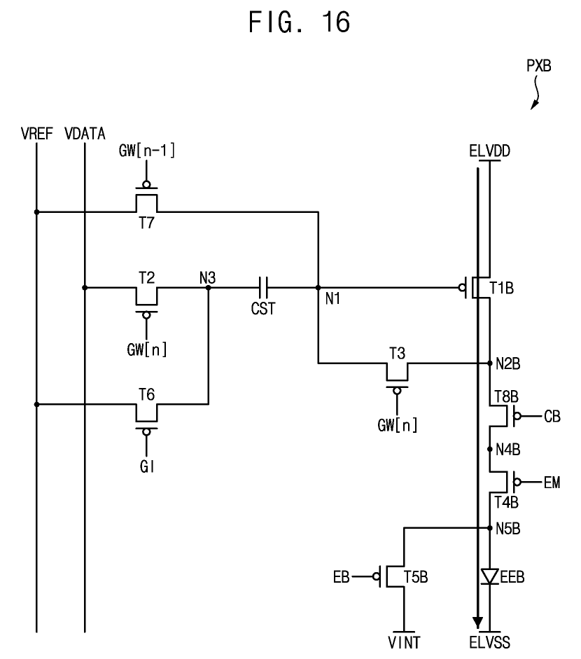

FIG. 16 is a circuit diagram illustrating an operation of a pixel circuit PXB of FIG. 11 in a fourth period TP4C of FIG. 12.

Referring to FIG. 12 and FIG. 16, in the fourth period TP4C, the fifth transistor T5B may be turned off in response to the bias signal EB. Accordingly, the driving current may be applied to the light emitting element EE. In the fourth period TP4A, the light emitting element EE may emit light based on the driving current.

Referring to FIG. 1, FIG. 11 to FIG. 16, in an emission period of a conventional pixel circuit, the reliability of the current applied to the conventional light emitting element included in the conventional pixel circuit may be deteriorated by the parasitic capacitance of at least one of transistors included in the conventional pixel circuit in an emitting period. For example, when the conventional pixel circuit displays black, a current may be applied to the conventional light emitting element by the parasitic capacitance. Accordingly, the conventional light emitting element may emit light. When the conventional pixel circuit displays black, the conventional light emitting element may emit light, such that the display quality is reduced.

In an embodiment of the invention, the frame period during which the pixel circuit PXB is driven may include a third period TP3C. In the third period TP3C, a current may flow along a path through the first transistor T1B, the eighth transistor T8B, the fourth transistor T4B and the fifth transistor T5B. Accordingly, the influence of the parasitic capacitance in the emitting period may be reduced. In an embodiment, for example, when the pixel circuit PXA displays black, the influence of the parasitic capacitance is reduced, such that the light emitting element EE may not emit light. Accordingly, the emitting reliability of the pixel circuit PXB may be improved, such that the display quality of the display panel 100 may be improved.

In an embodiment, the pixel circuit PXB may further include the eighth transistor T8B. In such an embodiment, the eighth transistor T8B may be turned on during the frame period. In an embodiment, the eighth transistor T8B may be weakly turned on during the frame period.

In the holding period, the initialization voltage VINT may be applied to the second node, such that the first node may be coupled by a voltage change of the second node N2. Accordingly, a voltage of the first node N1 may be changed. In the holding period, when the voltage of the first node N1 is changed, a reliability of the driving current may be deteriorated. When the reliability of the driving current may be deteriorated, an emission reliability of the pixel circuit may be deteriorated.

In an embodiment, the eighth transistor T8B may maintain a turned-on state during the frame period in the holding period, such that the voltage change of the second node N2B may be reduced. In an embodiment, the eighth transistor T8B may be weakly turned on in the holding period, such that the voltage change of the second node N2B may be reduced. In the holding period, the voltage change of the second node N2B may be reduced, such that the voltage change of the second node N2B by coupling of the voltage change of the second node N2B may be reduced. Accordingly, a reliability of the driving current may be improved, such that an emission reliability of the pixel circuit PXB may be improved.

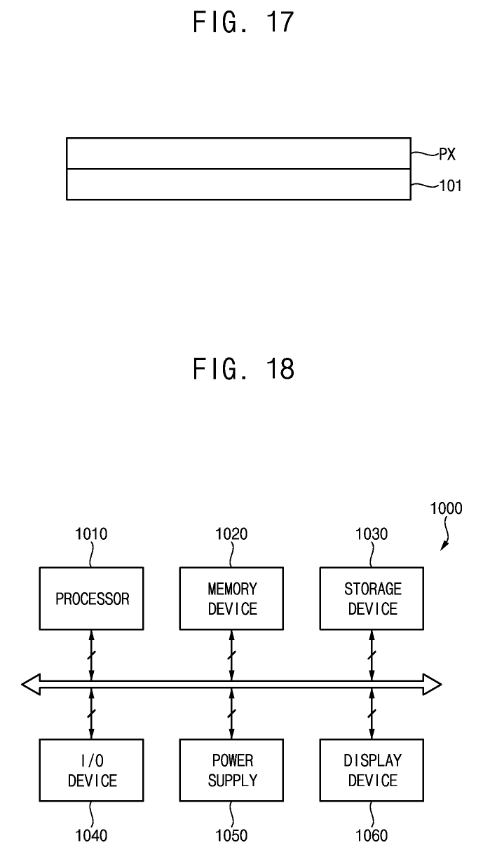

FIG. 17 is a diagram illustrating an embodiment of pixel circuit PX of FIG. 1 disposed on a substrate 101.

Referring to FIG. 1 and FIG. 17, an embodiment of the pixel circuit PX may be located (or disposed) on a substrate 101. In an embodiment, the substrate 101 may be a silicon-based substrate. In an embodiment, the pixel circuit PX may be located on a silicon-based substrate.

The silicon-based substrate may include a single-crystal silicon wafer, a polycrystalline silicon wafer, or an amorphous silicon wafer. A semiconductor layer may be formed on the silicon-based substrate through a semiconductor process. In an embodiment, for example, the silicon substrate on which the semiconductor layer is formed may be a silicon semiconductor substrate.

In an embodiment, the semiconductor layer may be formed on the silicon-based substrate through a complementary metal oxide semiconductor (CMOS) process. The semiconductor layer may include a pixel circuit in the form of a CMOS. In an embodiment, for example, the pixel circuit PX may include a CMOS circuit including a P-type transistor and an N-type transistor. Accordingly, the display device 1 may be a display-on-silicon (DOS, or light emitting diode-on-silicon (LEDoS)) having a light emitting structure on a silicon semiconductor substrate.

The pixel circuit PX may be located on a silicon-based substrate, such that voltage levels of input signals applied to the pixel circuit PX may be set more precisely. The pixel circuit PX may be located on a silicon-based substrate, such that at least one of the transistors included in the pixel circuit PX may be metal oxide semiconductor (MOS) transistor. Accordingly, the driving stability of the at least one transistor may be improved. Accordingly, a driving stability and an emission reliability of the pixel circuit PX may be improved.

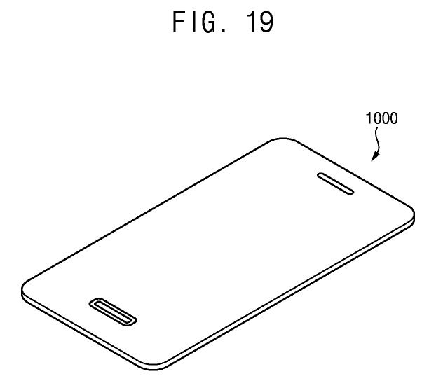

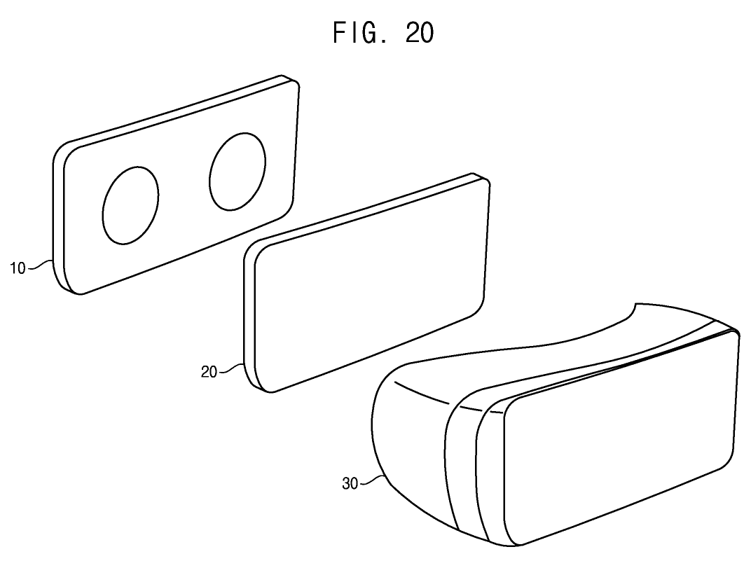

FIG. 18 is a block diagram illustrating an electronic device 1000 according to an embodiment of the invention. FIG. 19 is a diagram illustrating an embodiment in which the electronic device of FIG. 18 is implemented as a smart phone.

Referring to FIG. 18, an embodiment of the electronic device 1000 may include a processor 1010, a memory device 1020, a storage device 1030, an input/output (I/O) device 1040, a power supply 1050, and a display device 1060. Here, the display device 1060 may correspond to the display device of FIG. 1, that is, the display device of FIG. 1 may be used as the display device 1060. In an embodiment, the electronic device 1000 may further include a plurality of ports for communicating with a video card, a sound card, a memory card, a universal serial bus (USB) device, another electronic device, etc.

In an embodiment, as illustrated in FIG. 19, the electronic device 1000 may be implemented as a smart phone. However, the electronic device 1000 is not limited thereto. In an embodiment, for example, the electronic device 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display device 1060 may be included in the I/O device 1040. The power supply 1050 may provide power for operations of the electronic device 1000. The display device 1060 may be coupled to other components via the buses or other communication links.

Referring to FIG. 19, an embodiment of the electronic device may be implemented as a smartphone, for example, but the invention is not limited thereto. The electronic device may be a television, a monitor, a laptop computer, or a tablet. Additionally, the electronic device may be a vehicle, e.g., an automobile.

FIG. 20 is a diagram illustrating an embodiment in which the electronic apparatus of FIG. 18 is implemented as a virtual reality display system.

Referring to FIG. 18 and FIG. 20, an embodiment of the virtual reality display system may include a lens unit 10, a display device 20 and a housing 30. The display device 20 is disposed adjacent to the lens unit 10. The housing 30 may receive the lens unit 10 and the display device 20. Although the lens unit 10 and the display device 20 may be received in a first side of the housing 30 in an embodiment as shown in FIG. 18, the invention may not be limited thereto. Alternatively, the lens unit 10 may be received in a first side of the housing 30 and the display device may be received in a second side of the housing 30. In an embodiment where the lens unit 10 and the display device 20 are received in the housing 30 in opposite sides, the housing 30 may have a transmission area to transmit a light.

In an embodiment, for example, the virtual reality display system may be a head mounted display system which is wearable on a head of a user. Although not shown in figures, the virtual reality display system may further include a head band to fix the virtual reality display system on the head of the user.

Alternatively, the virtual reality display system may have the form of smart glasses implemented in the shape of glasses.

In an embodiment, the electronic device may be implemented as an augmented reality display system, a mixed reality display system, or an extended reality display system.

The display device according to embodiments described herein may be applied to a display device included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel circuit comprising:
a driving transistor including a control electrode connected to a first node, a first electrode which receives a first power voltage and a second electrode connected to a second node, wherein the driving transistor generates a driving current based on a voltage of the first node;
a write transistor which applies a data voltage to the driving transistor in response to a write gate signal;
a control transistor including a control electrode which receives a control signal, a first electrode connected to the second node and a second electrode connected to a fourth node;
an emission transistor which connects the fourth node and a fifth node to each other in response to an emission signal;
a light emitting element initialization transistor which applies an initialization voltage to the fifth node in response to a bias signal; and
a light emitting element including a first electrode connected to the fifth node and a second electrode which receives a second power voltage,
wherein the control signal is a direct current voltage.

2. The pixel circuit of claim 1, wherein the direct current voltage is a voltage which turns on the control transistor.

3. The pixel circuit of claim 1, wherein a frame period, during which the pixel circuit is driven, includes a write period, a holding period and an emission period,
wherein in the write period, the write gate signal has an activation level,
wherein in the holding period, the bias signal has an activation level, and the emission signal has an activation level, and
wherein in the emission period, the driving current is applied to the fifth node.

4. The pixel circuit of claim 3, wherein in the holding period, the control transistor is turned on, the emission transistor is turned on, and the light emitting element initialization transistor is turned on.

5. The pixel circuit of claim 1, further comprising:
a storage capacitor including a first electrode connected to the first node and a second electrode connected to a third node;
a first initialization transistor which applies a reference voltage to the third node in response to an initialization gate signal;
a second initialization transistor which applies the reference voltage to the first node in response to a previous write gate signal; and
a compensation transistor which connects the first node and the second to each other node in response to the write gate signal, and
wherein the write transistor applies the data voltage to the third node in response to the write gate signal.

6. The pixel circuit of claim 5, wherein a frame period, during which the pixel circuit is driven, includes first to fourth periods, and
wherein in the first period, the bias signal has an activation level, the emission signal has an inactivation level, the previous write gate signal has an activation level, and the initialization gate signal has an activation level.

7. The pixel circuit of claim 6, wherein in a second period following to the first period, the bias signal has an activation level, the emission signal has an inactivation level, the previous write gate signal has an inactivation level, the initialization gate signal has an inactivation level, and the write gate signal has an activation level.

8. The pixel circuit of claim 7, wherein in the second period the driving transistor and the compensation transistor are turned on.

9. The pixel circuit of claim 7, wherein in a third period following to the second period, the bias signal has an activation level, the emission signal has an activation level, and the write gate signal has an inactivation level.

10. The pixel circuit of claim 9, wherein in the third period, the light emitting element transistor is turned on, the emission transistor is turned on, and the control transistor is turned on.

11. The pixel circuit of claim 9, wherein in a fourth period following to the third period, the bias signal has an inactivation level, and the emission signal has an activation level.

12. The pixel circuit of claim 6, wherein during the first to fourth periods, the control signal is maintained as a control voltage.

13. The pixel circuit of claim 5, wherein the write transistor includes a control electrode which receives the write gate signal, a first electrode which receives the data voltage and a second electrode connected to the third node,
wherein the compensation transistor includes a control electrode which receives the write gate signal, a first electrode connected to the second node and a second electrode connected to the first node,
wherein the emission transistor includes a control electrode which receives the emission signal, a first electrode connected to the fourth node and a second electrode connected to the fifth node,
wherein the light emitting element transistor includes a control electrode which receives the bias signal, a first electrode which receives the initialization voltage and a second electrode connected to the fifth node,
wherein the first initialization transistor includes a control electrode which receives the initialization gate signal, a first electrode which receives the reference voltage and a second electrode connected to the third node,
wherein the second initialization transistor includes a control electrode which receives the previous write gate signal, a first electrode which receives the reference voltage and a second electrode connected to the first node, and
wherein the control transistor includes a control electrode which receives the control signal, a first electrode connected to the second node and a second electrode connected to the fourth node.

14. A pixel circuit comprising:
a driving transistor including a control electrode connected to a first node, a first electrode which receives a first power voltage and a second electrode connected to a second node, wherein the driving transistor generates a driving current based on a voltage of the first node;
a write transistor which applies a data voltage to the driving transistor in response to a write gate signal;
an emission transistor which connects the second node and a fourth node to each other in response to an emission signal;
a light emitting element initialization transistor which applies an initialization voltage to the fourth node in response to a bias signal; and
a light emitting element including a first electrode connected to the fourth node and a second electrode which receives a second power voltage,
wherein the emission signal toggles between a first emission voltage and a second emission voltage lower than the first emission voltage, and
wherein an absolute value of the second emission voltage is lower than a value obtained by subtracting an absolute value of a threshold voltage of the emission transistor from a value obtained by adding a voltage of the second electrode of the driving transistor and the second power voltage.

15. The pixel circuit of claim 14, wherein a frame period, during which the pixel circuit is driven, includes a write period, a holding period and an emission period,
wherein in the write period, the write gate signal has an activation level,
wherein in the holding period, the bias signal has an activation level, and the emission signal has an activation level, and
wherein in the emission period, the driving current is applied to the fourth node.

16. The pixel circuit of claim 15, wherein in the emission period, the emission signal has a third emission voltage lower than the second emission voltage.

17. The pixel circuit of claim 14, further comprising:
a storage capacitor including a first electrode connected to the first node and a second electrode connected to a third node;
a first initialization transistor which applies a reference voltage to the third node in response to an initialization gate signal;
a second initialization transistor which applies the reference voltage to the first node in response to a previous write gate signal; and
a compensation transistor which connects the first node and the second node to each other in response to the write gate signal, and
wherein the write transistor applies the data voltage to the third node in response to the write gate signal.

18. The pixel circuit of claim 17, wherein a frame period, during which the pixel circuit is driven, includes first to fourth periods, and
wherein in the first period, the bias signal has an activation level, the emission signal has an inactivation level, the previous write gate signal has an activation level, and the initialization gate signal has an activation level.

19. The pixel circuit of claim 18, wherein in a second period following to the first period, the bias signal has an activation level, the emission signal has an inactivation level, the previous write gate signal has an inactivation level, the initialization gate signal has an inactivation level, and the write gate signal has an activation level.

20. An electronic device comprising:
a display panel including a pixel circuit;
a gate driver which outputs gate signals to the pixel circuit;
an emission driver which outputs an emission signal to the pixel circuit;
a voltage generator which applies a power voltage to the display panel;
a driving controller which controls the gate driver, the emission driver and the voltage generator based on an input control signal; and
a processor which outputs the input control signal,
wherein the pixel circuit includes:
a driving transistor including a control electrode connected to a first node, a first electrode which receives a first power voltage and a second electrode connected to a second node, wherein the driving transistor generates a driving current based on a voltage of the first node;
a write transistor which applies a data voltage to the driving transistor in response to a write gate signal;
a control transistor including a control electrode which receives a control signal, a first electrode connected to the second node and a second electrode connected to a fourth node;
an emission transistor which connects the fourth node and a fifth node to each other in response to the emission signal;
a light emitting element initialization transistor which applies an initialization voltage to the fifth node in response to a bias signal; and
a light emitting element including a first electrode connected to the fifth node and a second electrode which receives a second power voltage,
wherein the voltage generator outputs the control signal, and
wherein the control signal is a direct current voltage.
